(19) United States
(12) Patent Application Publication
(10) Pub. No.: US 2007/0108288 A1
(43) Pub. Date: May 17, 2007

(54) Method and apparatus for novel reading of surface structure bar codes

(76) Inventors: Gregory T. Caskey, Holland, MI (US); Roland E. DeGraaf, Holland, MI (US); Robert J. VanArk, Holland, MI (US); Nicki P. Sonpar, Redondo Beach, CA (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/600,636

(22) Filed: Nov. 16, 2006

Related U.S. Application Data
(60) Provisional application No. 60/737,164, filed on Nov. 16, 2005.

(51) Int. Cl. G06K 7/10

(52) U.S. Cl. 235/462.08

(57) ABSTRACT

The method and apparatus herein described, and methods and apparatus similar to same, provide a novel method of extracting bar code information from surfaces where the codes are formed by either depressions or bumps on a surface. One particular embodiment is the extraction of DataMatrix 2D bar code patterns and subsequent analysis for content from markings made on forged steel parts that have surface defects that render current state of the art readers ineffective. The method and apparatus described in the present invention disclose differences from the current state of the art in that the present method provides for analysis if images arising from surface morphology itself instead of simply contrast in a standard camera image brought out by typical directional or specifically non-directional illumination.

### CROSS-REFERENCE TO RELATED APPLICATIONS

This application claims priority from U.S. Pat. application Ser. No. 60/737,164, filed Nov. 16, 2005, entitled METHOD AND APPARATUS FOR NOVEL READING OF SURFACE STRUCTURE BAR CODES, which is incorporated by reference herein in its entirety.

### TECHNICAL FIELD AND BACKGROUND OF THE INVENTION

The present invention relates to bar code reading and, more specifically, to extracting bar code information from surfaces where the codes are formed by either depressions or bumps on the surface.

Bar codes provide convenient and useful machine readable data that contain important information, which can used for a variety of purposes, such as by producers, suppliers, manufacturers, sorters, product stocking personnel, and a variety of other functions involved in a modern supply chain. In general, markings must be relatively intact, with few defects, for reliable reading. However, good markings are not always possible and so limit the usefulness of readers. Moreover, such markings are not limited to labels that are affixed to the product and may instead be integral to the product itself. Marking of products directly on the product surface can provide important links for later use. For example, aircraft parts are often marked with model and serial numbers, which will indicate their source of origin. Automotive parts can be similarly directly marked to assist manufacturers in cases of recall.

In all cases, the data are presented in usually one of two forms: Human Readable and Machine Readable. A hybrid type is human readable with the characters being understandable by visual inspection, and a computer program that can view the human readable code and then interpret the characters directly through a process called optical character recognition (OCR) or by verifying characters through a procedure known as optical character verification (OCV), both known to those skilled in the art.

Machine readable codes are preferably stored in non-human-readable form for several reasons. First, the devices that can read the codes do better with square or rectangular patterns. This is, in part, owing to the nature of the devices available for image acquisition, which themselves are usually of a digital camera type and so have a square or rectangular grid of pixels. Moreover, computer codes are easier to arrange in square arrays of numbers than in some other form. Another reason is that human readable codes can sometimes be confusing. Take the numeral 8 and the character B (capital B) as an example, represented by a series of dots that, when connected, make up the character desired. If the dots are somewhat out of position, which often happens with impact printing, then these two characters may be confused with one another. Also, if some dots are missing for some reason, then the computer code may get equally good matches to more than one character.

As noted, bar codes have many applications. Automotive parts are marked for a variety of reasons. One reason is to comply with the TREAD ACT of Congress, requiring the ability to trace parts from a defective vehicle back to the place where the part was manufactured. The ability to limit subsequent product recalls to a specific batch of parts can significantly reduce the cost and improve the benefit of both safety and functional recalls by limiting to only those vehicles likely to have the problem. Limiting a recall to a relatively small group can make recalls less costly and, therefore, more likely. Moreover, the inconvenience to consumers is limited to those who may actually have the problem. This is one reason for marking parts, but not the only reason.

A second reason is simply to follow parts through the manufacturing process itself, to keep track of how the process is working and how the product quality is varying with time or components. This is particularly important when parts are mated together and this mating cannot be interchanged since the matching is done as part of the manufacturing process itself. Such items could be as simple as matching transistors of a particular gain together for use in an electronic circuit to as complex as mating two gears together so that they mesh properly and do not bind under the stresses of operation.

Parts can be marked by a variety of methods. As noted, bar codes can be applied to labels, which are then applied to the part. Direct marking methods include ink markings applied directly on a part's surface or on its packaging. They may be embossed into a part, printed by impact markings, or otherwise formed as integral to the part. The markings may be depressed into the surface (dips or depressions) or may project outward from the surface (bumps). Where the bar codes are impressed into the actual part surface and become integral to the part, such marks then materially alter the surface of the part. When the mark is subsequently read, the reader must distinguish between the components of the mark and the rest of the part surface. The complexity arises because typical part surfaces are not controllable in the way a label surface is controllable. The surface may have visual or structural striations, scratches, may rust or have one or more myriad characteristics that make it difficult for automated readers to distinguish the bar code markings from other features of the part surface. This makes “reading” the mark difficult and, in some cases, impossible by conventional automated means. At the very least, some parts are marginally or unreliably read.

These marks may therefore be two dimensional. The two dimensional nature of the marks means simply that the pattern of marks has a length and width, both being important. This contrasts with a one dimensional bar code, typically found in retail product universal product code (UPC) symbols, where the product code is encoded into only one dimension of the symbol—perpendicular to the length of the individual bars. More information can be encoded more compactly by using two-dimensional (2D) symbols.

When forged steel parts are marked, for example, with 2D bar codes, the parts have a variety of surface conditions as they proceed through the manufacturing process, but are typically marked at the start of the manufacturing process. The parts are marked via impact pin printing with a (2D) bar code, one example being a DataMatrix (TM) code. The DataMatrix code is typically comprised of a square array, for example 14 by 14 dot positions, with serial numbers encoded in the matrix using an error correction method known to those skilled in the art of DataMatrix as the Reed-Solomon Error Correction Code (ECC200), though other types of encoding and decoding can be employed. The problems encountered in these forged steel parts are myriad. As would be understood, a single mark (such as a bar code) of good quality can be visually degraded significantly by the quality of the surface as the production process proceeds. For example, a forged steel part is first machined, then hardened, then ground, then coated and finally assembled. Prior to coating, the surface can rust or otherwise interact chemically with its surroundings. Certain actions to remove rust can cause further problems. For example, beadblasting to remove rust can result in a highly variable surface. Heat treating can leave streaky stains on the surface, as can other processing features. Coating a completely machined part can change the surface reflectivity altogether, requiring an entirely different lighting regime from uncoated parts. Consequently, the surfaces of forged steel parts can rust, may have been bead-blasted, have oil stains in some cases, or may have very dark surface coatings. In these cases, ordinary camera based readers fail to give consistent readings of the 2D bar codes.

Accordingly, there is a need for a method and apparatus that provides a more reliable reading of these codes.

### SUMMARY OF THE INVENTION

Accordingly, the present invention provides a method and apparatus for reading bar codes that offers improved reliability over conventional methods and involves the use of 3D (three dimensional) machine vision methods. The apparatus and specific embodiments described herein use structured lighting and an imaging device (such as a camera, which is selected based on end user needs for speed and the like) and an apparatus that provides for scanning the surface of a part with the structured light and an apparatus for acquiring profiles of the light on the surface of the part. The profiles are then assembled into an image that is then analyzed for the presence and content of surface markings on the part, such as a bar code. One suitable imaging method is described in U.S. Pat. No. 6,542,235, which is herein incorporated by reference in its entirety, with the modifications described herein for evaluating the image for reading such surface markings, whether bar codes or otherwise.

In one form of the invention, a method of reading surface markings on a part, which are formed by changing surface structure of the part includes illuminating the surface of the part with a light line, scanning the part with the light line, collecting images of the light line as it interacts with the part, assembling the images into a characteristic image. Further, the characteristic image is evaluated to locate, identify, and extract the surface markings.

In one aspect, the surface markings form a bar code. For example, the surface markings may be imprinted in the part.

In another aspect, the characteristic image is evaluated to locate identifying and extract the surface markings that are in the form of an array of dots marked on the surface of the part.

In yet another aspect, the part that is read is forged steel.

According to other aspects, the part is illuminated with a structured radiation source. For example, the structured radiation source illuminates the part with light, such as visible light. Further, the structured radiation source may illuminate the part with infrared light.

In other aspects, the part is illuminated with a laser line generator. The images are collected with an imaging device, such as a camera. In addition, the part is scanned with the light line, for example the part may be moved by a conveyor, a driven table, or a rotating stage, while the part is being illuminated.

Alternately, the light line may be moved across the part with a reflector. In yet another aspect, the light line is moved by tilting the radiation source.

As would be understood, the part may be scanned using a number or combination of different methods.

In a further aspect, the width of the light line is evaluated.

According to yet another form of the invention, an apparatus for reading surface markings, which are formed by changing surface structure of a part, includes a scanning means for scanning a part, a structured radiation source projecting structured light, an imaging means, and a processor. The scanning means moves the part or the projected structure light wherein the structured light scans at least a region of the part. The imaging means is sensitive to the radiation source and generates images of the structured radiation projected onto the part to obtain characteristics of the image. The images are then assembled and stored as a characteristic image, which the processor analyzes to extract the surface markings.

In one aspect, the structured radiation source comprises a laser line generator.

In another aspect, the imaging means comprises a digital camera.

The scanning means may comprise a conveyor, a driven table, a rotating stage, or a reflector.

In yet another aspect, the scanning means comprises a tilting means that tilts the structured radiation source to provide for the scanning.

Alternately, the scanning means may move the structured radiation source in a substantially linear manner. Further, the scanning means may move both the structured radiation means and the imaging means in a substantially linear manner.

In another form of the invention, a bar code reader system includes a structured light source, an imaging device, and a processor, which is in communication with the imaging device. The light source directs a line of light on a bar coded part to be read. The imaging device generates profile signals in response to the line of light on the part with a processor receiving the profile signals and assembling the profile signals into a surface structure image and with the processor analyzing the surface structure image to detect and preferably extract the bar code structure on the part.

In another form of the invention, a bar code reader system includes a structured light source, an imaging device, and a processor, which is in communication with the imaging device. The light source directs a line of light onto the bar coded part to be read with the imaging device generating profile signals in response to the line of light on the part. The processor receives the profile signals from the imaging device and evaluates the widths of the lines of the light of the profile signals to detect the presence of a bar code structure on the part.

According to yet another form of the invention, a bar code reader system includes a structured light source, an imaging device, and a processor, which is in communication with the imaging device. A line of light from the light source is directed onto a bar coded part to be read with the imaging device generating profile signals in response to the line of light on the part. The processor receives the profile signals from the imaging device and evaluates the summed brightness of the profiled signals to detect the presence of a bar code structure on the part.

In any of the above embodiments, the light source may comprise an infrared light source, an ultraviolet light source, an x-ray radiation source, a structured beta-ray radiation source, a structured gamma-ray radiation source, a structured acoustic radiation source, or a structured radio emission radiation source.

Similarly, in any one of the above systems, the imaging device may comprise a camera, such as a high speed camera. Suitable cameras may include a CCD camera, CID camera, a pin diode camera, a CMOS camera or an infrared camera.

Further, in any one of these embodiments, the processor may comprise a computer, a digital signal processor, or a processor of an image of the imaging device.

In a further aspect of the invention, any one of these embodiments may also include a means for scanning the part with the structured light. For example, the means for scanning may comprise an x-y table, a linear actuator, a robot, a pan/tilt stage, a laser scanner mirror devices, a rotational stage, or the like.

According to another form of the invention, a method of reading a bar code on a part includes directing structured light onto a first set of the part, reading profiles of the light on the first side of the part with an imaging device, and gathering the profiles from the imaging device and assembling them into a height image. Further, the height image is evaluated to detect the presence of a bar code on the part.

Another method of reading a bar code on a part includes directing a line of structured light onto a first side of a part, reading a profile of the line of light on the first side of the part with an imaging device, evaluating the line width of the profile from the imaging device to detect the presence of a bar code.

According to yet another form, a method of reading a bar code on a part includes directing structured light onto a first side of a part, scanning the first side of the part with the structured light, reading the profiles of the light on the first side of the part, and evaluating the brightness of the profiles to detect the presence of a bar code on the part.

Accordingly, the present invention provides a vision system and method that may be used to analyze for the presence and content of a bar code, such as an impact printed serial number on a part. Further, the method and system provides a method of analysis that allows the extraction of bar code information from a surface independent from the existence of surface defects that often render the prior art readers ineffective.

These and other objects, advantages, purposes, and features of the invention will become more apparent from the study of the following description taken in conjunction with the drawings.

### DETAILED DESCRIPTION OF THE DRAWINGS

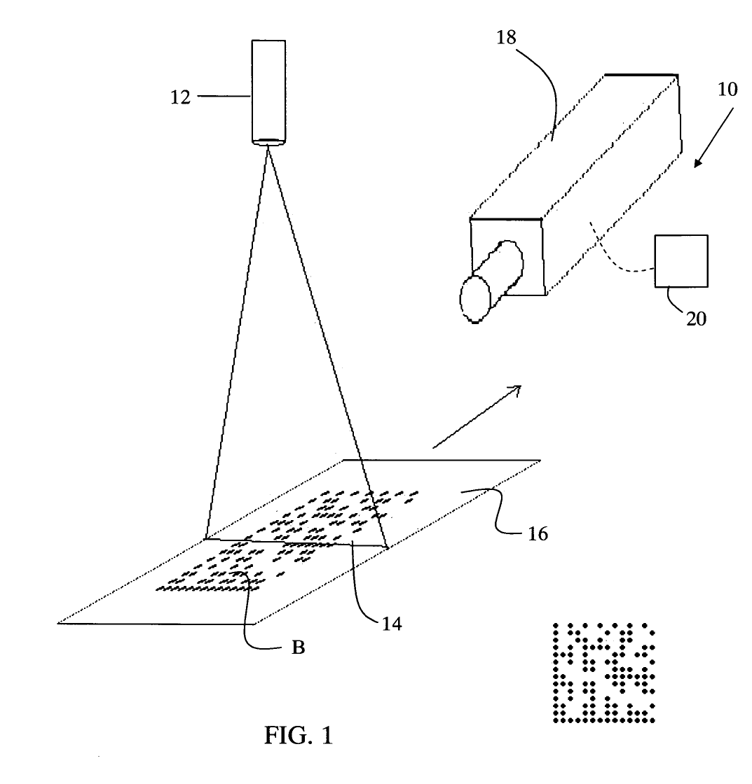

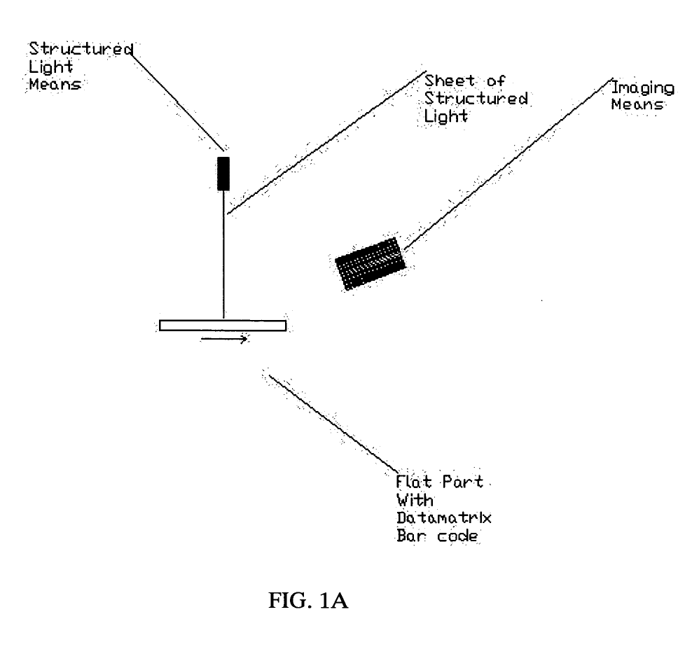

FIG. 1 is a schematic drawing of the bar code reader system of the present invention;

FIG. 1A is a schematic drawing of the system of FIG. 1 illustrating one example of the relative positioning of the system components relative to the object being scanned;

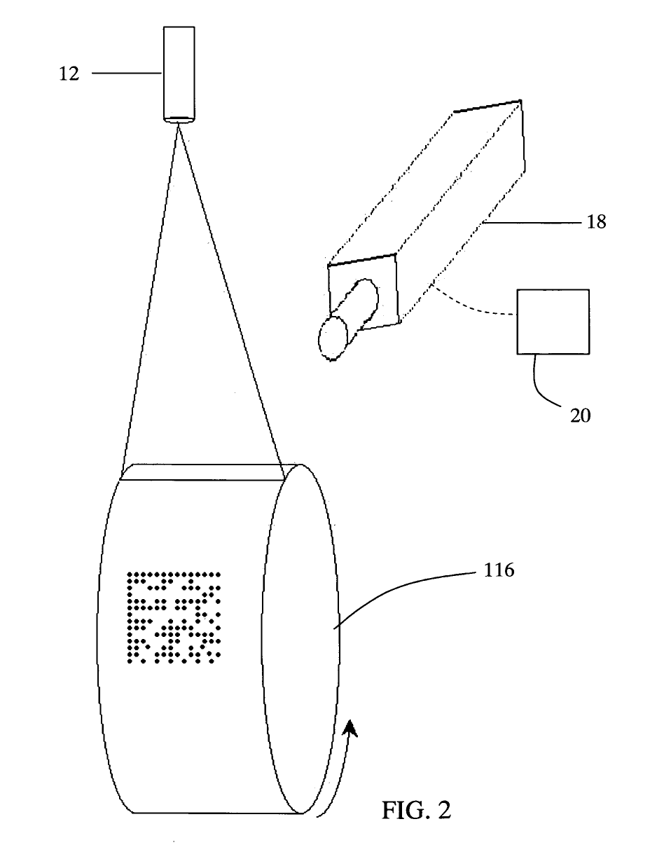

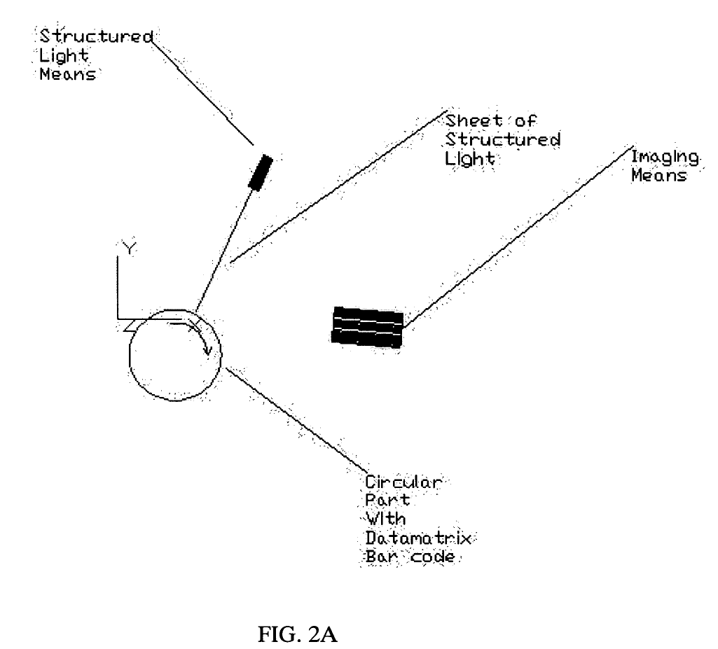

FIG. 2 is a schematic drawing of another embodiment of the bar code reader system of the present invention;

FIG. 2A is a schematic drawing of the system of FIG. 2 illustrating one example of the relative positioning of the system components relative to the object being scanned; and

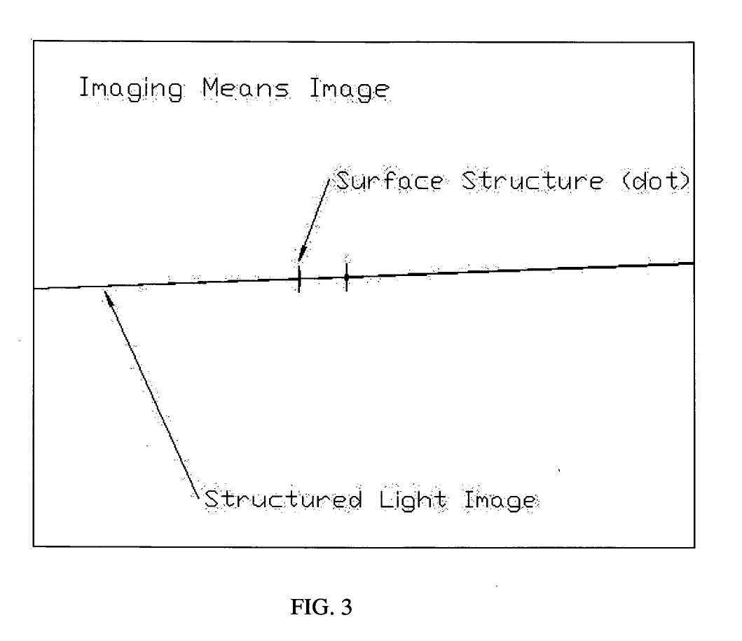

FIG. 3 is a schematic representation of the light interacting with a surface discontinuity on a part illustrating the variation in width of the line of light at the discontinuity.

### DETAILED DESCRIPTION OF THE PREFERRED EMBODIMENTS

Referring to FIG. 1, the numeral 10 generally designates a bar code reader system of the present invention. System 10 includes a structured light source 12, which directs a line of light 14 onto a part 16, and an imaging device 18, which views the line of light 14 as it interacts with the part 16. Further, system 10 includes a device for moving the part relative to the line of light, for moving the line of light across the part, or for moving the imaging device and the line of light across the part to thereby scan the part. In the illustrated embodiment, part 16 is supported underneath light source 12 and moved by a conveying stage that carries the part underneath the light source. Other suitable devices to enable scanning of a part include x-y tables, linear actuators, robots, pan/tilt stages, laser scanner mirror devices such as are found in supermarkets, rotational stages and many other such scanning means that can allow for gathering a plurality of “profiles” of the structured radiation means for assembly, analysis and/or interpretation of the marking(s) on a part.

As the part is scanned, the surface structure, for example bar code B, causes deviation in the line of light as viewed from imaging device 18, which can be analyzed and recorded as a profile because it shows a line of light that changes in height with the change in surface height. For example, as best seen in FIG. 1A, the light is directed toward the part so that it is generally orthogonal to the upper or facing surface of the part while the imaging device is oriented so that it views the light as it interacts with the part from an inclined angle. These profiles are then assembled into an image by a processing device 20, which is in communication with imaging device 18, or which may be incorporated into imaging device 18. For further details of this imaging process, reference is made to U.S. Pat. No. 6,542,235, which is incorporated herein in its entirety.

In the illustrated embodiment, bar code B is represented as a DataMatrix code. The DataMatrix code appears as a square pattern, which consists of a 14×14 dot array pattern, which is encoded using a read error correction code known in the art as ECC200. The array consists of a plurality of depressions or bumps in the surface of the part. Therefore, in addition to assembling the profiles into an image, processor 20 uses the structure of the structured radiation, meaning the line light, that is reflected into the imaging device 18 to glean information sufficient to read the bar code.

In the illustrated embodiment, imaging device 18 comprises a camera, such as a CMOS camera. Suitable CMOS cameras are available under model number SV2112 from Epix, Inc. of Buffalo Grove, Ill., USA. Light source 12 preferably comprises a line generator, such as laser line generator. Suitable laser line generators include red diode laser line generators manufactured by Laseris and sold by Stocker & Yale Canada of Montreal, Quebec, Canada. Processor 20 may comprise a computer, such as a typical IBM compatible PC. For example, the computer may have a Celeron processor at 350 MHz clock speed.

Parts that may be read by system 10 include forged automotive parts. However, the present system may be also used on a variety of parts, including parts of various shapes and sizes, of different materials, such as steel, aluminum, titanium, iron, plastics of various sorts, ceramics and glass, and agglomerations of materials, alloys and other variations.

As noted above, the bar code B may comprise a DataMatrix (RVSI Acuity CiMatrix, of Nashua, N.H., USA, public domain standard available as ISO document 16022) code, which is typically a 14×14 dot array pattern and the encoding is, for example, a Reed-Solomon error correction code known in the art as ECC200. System 10 may read flat or circular parts. When the parts are circular in nature, the pattern is typically placed on the flat side portion of the part but at an undetermined angle around the axis of symmetry, with the DataMatrix code appearing as a square pattern and the human readable code adjacent but separate from the DataMatrix code and printed around a circular arc of radius equal to the distance from the center of part symmetry to the human readable code. As would be understood, the parts may be from various stages in the manufacturing process, including freshly machined, machined and heat treated, heat treated and rusted, heat treated, rusted then bead blasted to remove rust and scale, and dark coated near finished product.

As previously noted, part 16 is located underneath light source 12 as shown in FIG. 1, with imaging device collecting profiles of the light line 14 as it interacts with part 16 and processor 20 assembling the various profiles of the light line into a full image, which is then analyzed. The results of the analysis is a pattern that is then subjected to an algorithm that first seeks the “finder lines” (two perpendicular lines of 14 dots each sharing a common corner and extending along two sides of the DataMatrix array) and “density lines” (lines that have every other dot marked and make up the other two sides, leaving a blank in the corner opposite to the shared dot of the finder lines). Then the image is analyzed to determine if dots are marked at various locations within this pattern. Once all the dots are identified, processor 20 then creates a black and white bitmap image where each dot location is represented by a square, with all squares abutting neighboring squares with no space between. If a dot is found at a particular location, the bitmap image square corresponding to that location is colored black, and otherwise remains white. There is also a white area entirely around the created pattern to represent what is called the “quite zone” around the DataMatrix pattern. Once this phase is completed, then the pattern is used as input to a standalone program designed to decode DataMatrix patterns. In this embodiment, a suitable program is available under the name ClearImage, which is a product of Inlite Research Corporation of Sunnyvale, Calif. USA.

The results of a test involving 8 such parts with differing surface conditions, using a Cognex 4000 or 4001 series smart camera (Cognex of Natick, Mass., USA), a conventional camera used in reading and decoding DataMatrix patterns, were all reported as unreliably read. This difficulty stems, in part, from using a standard image from an area scan (2D) camera and methods, and from using standard area camera image processing tools typical in machine vision, where changes in surface contrast can obscure the DataMatrix code. As surface conditions change, the reflectivity differences stemming from the surface changes across the surface that need to be analyzed become almost equal to the contrast difference between the dots and the surface itself. This creates a very low signal to noise ratio, where the signal is the desired pattern and the noise is the variation in the appearance of the surface due to the various effects (e.g. rust, etc.) previously mentioned.

Using the present system, the DataMatrix codes of all 8 parts were read correctly, as verified by the adjacent human readable codes, twice through. This represents a minimum 100% improvement in readability over conventional methods.

For the DataMatrix and human readable codes on the sides of a circular part, the surface variations made reading by standard methods difficult to impossible. Twelve such parts were tested using the present system. The setup was similar to that shown in FIGS. 2 and 2A but with human readable code next to the DataMatrix pattern. The part was located on a rotatable stage with the processor controlling a motor that permitted profiles of line width to be acquired at roughly equal intervals. The results were that in about 7 of the cases, the parts read properly in two separate passes. Of the remaining 5 parts, 4 read at least one out of three times, and with some adjustments read 2 out of three times. One part was unreadable without considerable adjustment of parameters used to extract the pattern.

In an alternate embodiment, imaging device 18 may include an IVP Ranger M50 camera, with the part supported on a rotating table, using a Yaskawa Electric America, Inc. (Waukegan, Ill.) SGMCS Direct Drive Sigma Series Servo Motor. The motor serves as a means to rotate a part, with a DataMatrix code on the outside of the cylinder. For example, in one test, the part was rotated at a rate of approximately 1 revolution per second. The part itself was approximately 7 inches in diameter. With this, 39 different parts were read using the present system, with the parts having surface conditions ranging from fresh and shiny metal, to grey metallic, to grey metallic with black streaks, to blackened surface conditions. All parts were imaged by rotational scanning, and the DataMatrix marks found, processed and interpreted within about 8 seconds per part. This is well within production rates for many high-value products, such as transportation drive train components. The result was that all parts were read properly, three times through. If parts had more than one mark on them, all marks were correctly read.

As noted above, light source 12 may include a laser source, such as a diode laser source, including a red diode laser source. Other suitable light sources include other structured radiation sources, such as structured ultraviolet light, structured x-ray radiation, structured beta-ray radiation, structured gamma-ray radiation, structured acoustic radiation from, for example, ultrasonic sources or sonar sources, structured radio emission radiation and other means of radiation.

Similarly, a variety of imaging devices that are sensitive to the structured radiation may be employed. Suitable processors include a variety of processors or computing devices that acquire, store, analyze and interpret markings, or some subset of these functions, and included in these are: personal computers, mainframe computers, digital signal processors, computers embedded in cameras, stand-alone computers, industrial computer processors, and many processors.

In another form of the invention, processor 20 evaluates the widths of the lines of light as seen by the imaging device 18 as the measure of the surface rather than the position of the line in the image. In this manner, only rapid variations in the surface that alter the direction of light reflection produces a signal. When a surface structure is encountered that is as sudden as an impact printed mark, the line light width as seen by the camera will increase it significantly.

Since the depressions (or bumps for that matter) in a surface that comprise the marking can be rather small, or the surfaces can be tipped, it is not always advantageous to employ the 3D imaging of U.S. Pat. No. 6,542,235. Tipped surfaces will change the height, hence the grayscale level as you go across the surface, making analysis time consuming. Moreover, undulations in the surface itself can be problematic as well, making it difficult to discern marking from other surface structure. To overcome thus, the present invention includes the additional method of using the structure of the structured radiation (light line) reflected to the camera itself to glean information. In this form, the width of the line as seen by the camera is used as a measure of the surface, rather than the position of the line in the image. In this way, only rapid variations in the surface that alter the direction of light reflection produce a signal. When a surface structure is encountered that is as sudden as an impact printed mark, the light line width as seen by the camera will increase significantly, and will provide a noticeable and measurable difference from the light line width in the absence of such a structure. This method differs substantially from light contrast methods that are used in video or still cameras typically used in machine vision because they do not view the thickness of the line.

In an alternative method, processor 20 sums up the total brightness of all pixels in a column of pixels (which run substantially perpendicular to the line of light). As a result, instead of getting the width of the line, processor 20 determines the weighted width of the line. It has been found that this method may be superior in some instances in improving the contrast of the DataMatrix code to their surrounding surfaces when the profiles are assembled together in a full image.

Any one of these methods of using the light lines to develop a full image for analysis may be used. In the first method, the profiles of the line of light as it interacts with the part are assembled into an image that shows surface structure. The imaging device detects where the light line is located vertically and/or horizontally in an image of the individual light line.

Thus, each image gives a geometric profile with heights varying as with the surface being imaged. In the second method, instead of constructing a profile of the height of the line of light, the method herein described uses the light line widths as the part is scanned from one side of the part to the other side of the part. The third method uses a weighted projection onto the vertical and/or horizontal axis of the camera. In each method, a single profile is produced within a series of such profiles gathered and assembled into a 3D image where the length and the width are what we associate with lengths and widths normally but the height may be a surface height or light line width or light line projection.

As an example of the second method (line width) for gathering profiles, FIG. 3 shows schematically the structured light (here a line of light) as imaged by a camera as the imaging means, illustrating the effect on line width that the DataMatrix surface indentation pattern can have in the imaging process. Measuring the vertical width of the light line in FIG. 3 (second method) can provide a numerical result that is two to three times that obtained from a vertical deviation of the line center. Moreover, measuring a summed brightness (third method) in the same area can provide another two to three times higher numerical value than the width alone, over that from a simple profile. This effect is similar for DataMatrix marks that are depressions as well as bumps in surfaces. In any event, the effect is relatively insensitive to surface coloration or variations in surface coloration. Typically the DataMatrix marks are distinct enough from other surface structure to permit good separation of mark elements from the rest of the surface even if the surface is itself highly structured or has significant color variation.

There are a variety of methods to gather profiles using the methods of this invention that provide useful ways around the presently available methods for reading surface structure based codes and markings. Imaging equipment such as ordinary CCD cameras can be used, but will normally be slow. Higher speed scanning can be done with specialty cameras that provide the user with control over the specific portions of the image to use. Two such cameras are employed in the embodiments. One is the SV2112 CMOS based camera manufactured by Epix, Inc. of Bufffalo Grove Ill. The second is a still faster camera specifically designed for 3D imaging. This is the Ranger M50 manufactured by IVP, Inc. of Linköping, Sweden and now sold by Sick-IVP of Minneapolis, Minn. in the USA. The former is used as an imager to transfer images of the profiles to a computer for extraction of each profile individually. The latter provides the profile extraction onboard, transferring the profile to the computer where we can program in any of the three methods of profile extraction. Both pc-based and onboard camera-based methods work equally well but the latter is much faster because the camera is designed for extracting profiles from lines of light via user selected algorithms.

Structured lighting can take many forms. For example, visible red laser line generators are readily available from Lasaris, a Canadian company owned by Stocker & Yale of Salem, N.H. USA. Since many imaging devices are sensitive to infrared light (IR) or near IR, line generators using such light may also be used, as may line generators that use other wavelengths of light. These methods are again outlined in our previous patent. We stress that the nature of the radiation itself is not important, only that it be purposely structured, and that the imager be sensitive to the radiation source. The embodiments and teachings we present are not intended to limit the application of the method.

Three dimensional imaging offers a unique way to provide this information. Since the method involves acquiring profiles, it is insensitive to surface coloration. Moreover, 3D methods can tolerate the minor surface pitting that occurs on beadblasting surfaces, and also on just the normal surface changes that can occur from rusting. Both of these effects wreak havoc on two dimensional imaging of a surface with a camera. For example, areas that are rusty will reflect light differently than areas that are not. With the 3D methods, this may be true as well, but since we look only at the profile, the actual surface reflectivity need only be sufficient to gather a profile. So color or lightness variations do not impose a substantial barrier to gathering images that can reveal the imprinted code when we use 3D techniques.

Results from our testing show that we can use this invention's 3D methods to accurately gather 3D images that reveal with substantially better clarity than standard 2D methods the DataMatrix codes in all of the various cases we've encountered. This includes pristine and relatively shiny surfaces, to bead blasted surfaces, to oil stained surfaces all the way to coated surfaces in their final form. We studied cases where standard methods available at present could not read the pattern reliably, or at all, were repeated two and three times in tests where only two or three readings were acquired. This resulted in 50% to 100% improvements in readability, and using essentially the same parameters for imaging and pattern extraction in almost all cases, and requiring only minor variations for certain cases.

The success of this methodology can be useful for both standard industrial imaging, and it can be useful in any area where pulling out identification information imprinted into a surface is difficult. The interpretation of the code itself is then done by standard methods that are incorporated into the invention as a final step in going from markings on a part to an interpreted code.

Although described in reference to a DataMatrix code, the present invention may be used on a variety of encoding means, including human readable codes and codes not directly human readable, such as codes that are comprised of dots, squares, rectangles or any other geometric shape that can be discerned from the surface.

Uses of this technology include reading bar codes for processes, as noted, related to manufacturing, but also related to distribution and sales, safety, security, homeland security, biological and chemical marking, and other areas where surface structure bar codes may be used.

Accordingly, the present invention describes the methods and apparatus that ready any surface structure related information in human or machine readable form. In particular, the methods and apparatus use an imaging device in conjunction with structured lighting, and either the height or the width of a structured light line or widths of a plurality of light lines are obtained and used to acquire, analyze and have available for interpretation or, in fact, interpreting either human readable patterns or patterns intended for machine reading, on all materials suitable for such surface structure. These surface structures may be depressed or raised patterns, including such patterns that are on labels, appliques, stickers, plates or the like that are in turn placed upon or attached to a surface of a part.

While the present invention is not limited to use on 2D symbols, we believe that 2D symbols illustrate the invention sufficiently to encompass one dimensional symbols (barcodes) as well, and even markings more complex than simple barcodes.

While several forms of the invention have been shown and described, other forms will now be apparent to those skilled in the art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. A method of reading surface markings on a part, which are formed by changing surface structure of the part, said method comprising:
illuminating the surface of a part with a light line;
scanning the part with the light line;
collecting images of the light line as it interacts with the part;
assembling the images into a characteristic image; and
evaluating the characteristic image to locate, identify, and extract the surface markings.

2. The method of claim 1 further comprising providing a part with surface markings forming a bar code.

3. The method of claim 2 wherein said providing a part includes providing a part with the surface markings imprinted in the part.

4. The method of claim 1, wherein said evaluating includes evaluating the characteristic image to locate and extract the surface markings wherein the surface markings are an array of dots marked on the surface of the part.

5. The method of claim 1, wherein said illuminating includes illuminating the part with a structured radiation source, such as visible light or infrared light

6. The method of claim 1, wherein said illuminating includes illuminating the part with a laser line generator.

7. The method of claim 5, wherein said collecting includes collecting images with an imaging device, such as a camera.

8. The method of claim 7, wherein said collecting further includes scanning the part with the light line.

9. The method of claim 8, wherein said scanning includes moving the part with a conveyor, a driven table, or a rotating stage while illuminating the part.

10. The method of claim 8, wherein said scanning includes (1) moving the light line across the part with a reflector or (2) moving the light line by tilting the structured radiation source.

11. The method of claim 8, wherein said scanning includes moving the part, the light line, or the imaging device in a substantially linear manner.

12. The method of claim 11, wherein said scanning includes moving both the light line and the imaging device in a substantially linear manner.

13. The method of claim 8, wherein said scanning includes tilting both the structured radiation source and the imaging device.

14. The method of claim 1, wherein said evaluating includes evaluating the width of said light line.

15. An apparatus for reading surface markings that are formed by changing surface structure of a part, said apparatus comprising:
a scanning device;
a structured radiation source projecting structured light onto a part;
an imaging device; and
a processor, said scanning device moving the part or said structured light wherein said structured light scans at least a region of said part, said imaging device being sensitive to said structured radiation source and generating images of said structured light projected onto the part to obtain characteristics of the image, said images being assembled and stored as a characteristic image, and said processor analyzing said characteristic image to extract the surface markings of the part.

16. The apparatus of claim 15, wherein said structured light is visible or infrared.

17. The apparatus of claim 15, wherein said structured radiation source comprises a laser line generator.

18. The apparatus of claim 15, wherein said imaging device comprises a digital camera.

19. The apparatus of claim 15, wherein said scanning device comprises a conveyor, a driven table, a rotating stage, or a reflector.

20. The apparatus of claim 15, wherein said scanning device comprises a tilting device for tilting said structured radiation source to provide for said scanning.

21. The apparatus of claim 15 wherein said structured radiation source generates a light line, and said processor evaluating the width of said light lines on the part.
